(19) United States
(12) Patent Application Publication
(10) Pub. No.: US 2008/0115637 A1
(43) Pub. Date: May 22, 2008

(54) Child safety restraint installation tool

(76) Inventor: Gerald Mayfield, Victoria, TX (US)

Correspondence Address: LAW OFFICE OF DAVID MCEWING, P.O. BOX 231324, HOUSTON, TX, 77023, US

(21) Appl. No.: 11/601,195

(22) Filed: Nov. 16, 2006

(51) Int. Cl. B25B 27/14; B25B 27/00

(52) U.S. Cl. 81/487; 29/278

(57) ABSTRACT

A child safety restraint installation tool that incorporates an upright hook device that can be inserted in the aperture of a male seatbelt component. The seatbelt end can be thereby pulled through the framework of the safety restraint device. The installation tool does not grasp or clamp to the seat belt component.

### RELATED APPLICATIONS

This application claims the benefit and priority to provisional application No. 60/731,181 filed Nov. 29, 2006 and entitled “EZ Buckle” and which is incorporated herein by reference.

### FIELD OF INVENTION

This invention pertains to a tool to assist in the attachment of car seat belts in the installation of a child safety restraint.

### BACKGROUND OF INVENTION

Several devices intended to assist the user in securing a child safety restraint are known. See patent issued to David M. Reese, U.S. Pat. No. 5,197,176 and patent issued to Dezarae J. Dittmar et al., U.S. Pat. No. 6,430,797, and both of which are incorporated by reference herein.

### SUMMARY OF INVENTION

A child safety restraint attachment tool comprising a handle, a shank and a hook component wherein the hook component engages with the male attachment of a seat belt and the hook component is substantially 90° to a plane of the shank. The tool may further comprise a reinforcement component attached to the shank and the hook. The tool may also further comprise a hook flange component.

### SUMMARY OF DRAWINGS

The accompanying drawings, which are incorporated by reference and constitute part of the specification, illustrate preferred embodiments of the invention. These drawings, together with the general description of the invention given above and the detailed description of the preferred embodiments given below serve to explain the principles of the invention.

FIGS. 1A and 1B illustrate a prior art tool showing a spring tensioned curved tongue used for clasping the seat belt.

FIG. 2A through 2C illustrate another prior art tool utilizing a spring clip oriented in the direction of the tool end and used to clasp the seat belt.

FIG. 3 illustrates one embodiment of the device subject of the invention comprising a handle, shank and hook component.

FIG. 4 illustrates the shank and hook component of the tool wherein the hook is inserted through the opening of the male end of the seat belt.

FIG. 5 illustrates a side view of the tool showing the hook component.

FIG. 6 illustrates a top view of the tool illustrating the handle

### DETAILED DESCRIPTION OF THE INVENTION

The tool of the invention is adapted to releasably attach the male end of the seat belt locking assembly to facilitate the extension of the male seat belt locking component through a child safety restraint so that the male end of the seat belt can be coupled with the female end of the seat belt to secure the child safety restraint to the seat of the vehicle.

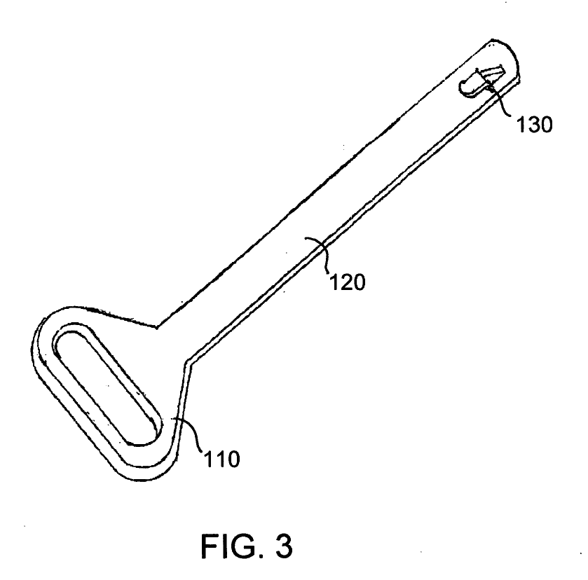

FIG. 3 illustrates a preferred embodiment of the invention, the tool 100, formed from a single length of suitable material, as for example, plastic or the like. The tool is preferably comprised of material that is a thin, lightweight, and flexible. The tool has a first end comprising a handle 110. The handle will be used to pull the tool and the hooked seat belt component. The tool also comprises a substantially flat and an elongated shank portion 120. This facilitates the threading of the tool and hooked seat belt component through the framework of the child safety restraint device. At the second end, the tool comprises a hook component 130. This is used to removeably attach the tool to the male attachment component of the seat belt. The hook component fits through the opening of the male attachment component. The hook can comprise an upright component positioned 90° to the orientation of the shank. The component may include optional reinforcement which is advantageous for the strain of pulling the seat belt around and through the frame of the child safety restraint can cause components of prior art devices to break or release the seat belt.

The tool of this invention is projected by the user either around or through the frame of a child safety restraint, where the user removeably attaches the male end of the seat belt assembly to the hook. As the tool is retrieved, the male end of the seat belt assembly extends and follows the path of the tool around or through the frame of the child safety restraint. Upon retrieving the male end of the seat belt assembly, the user couples the male and with a female end (not shown) to lock the child safety restraint securely in place against a seat in a vehicle.

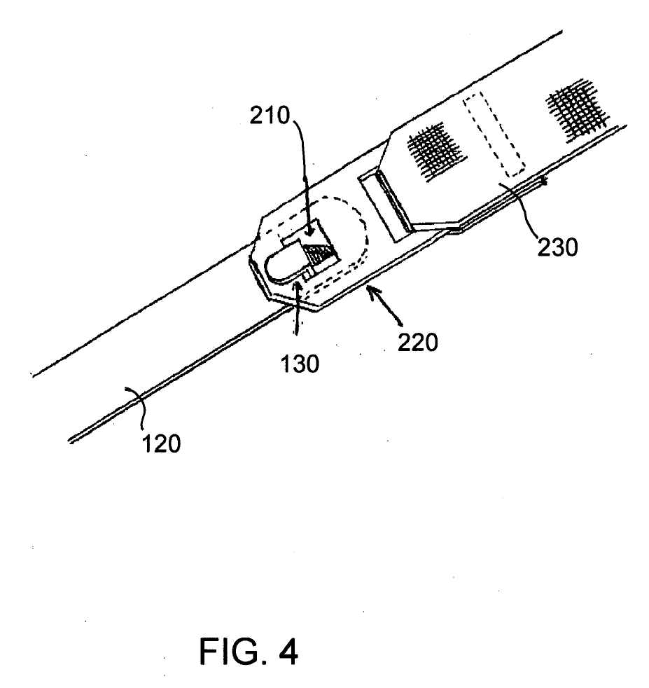

As shown in FIG. 4 when the tool is employed for engaging a male end 220 of a seat belt locking assembly, the hook component 130 extends through the hole 210 in the male end 220 of the seat belt locking assembly.

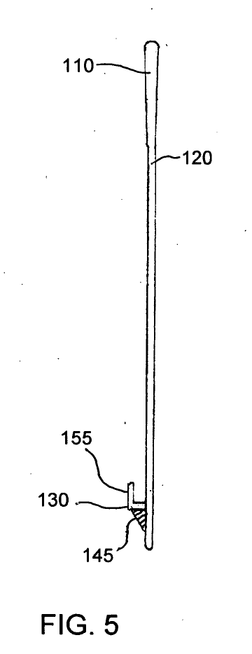

FIG. 5 illustrates a side view of the tool showing the hook component extending 90° from the plane of the tool shank. An optional hook reinforcing subcomponent 145 and optional hook flange component 155 are also illustrated. The hook flange component is oriented substantially parallel to the tool shank and normal to the hook. Unlike the bent or folded design of the prior art, the open design of the hook flange component of the present invention can facilitate the capture of the male end of the seat belt locking assembly.

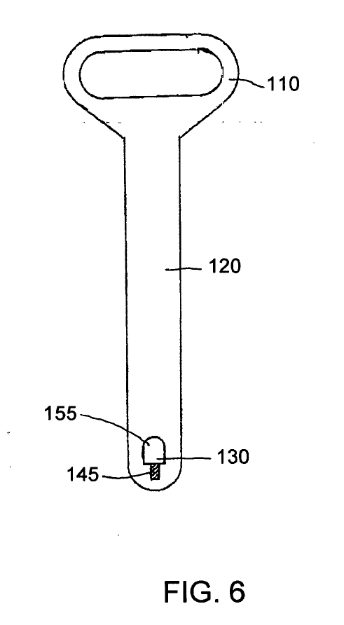

FIG. 6 illustrates a top view of the tool also showing the hook flange 155 and the hook reinforcing subcomponent 145.

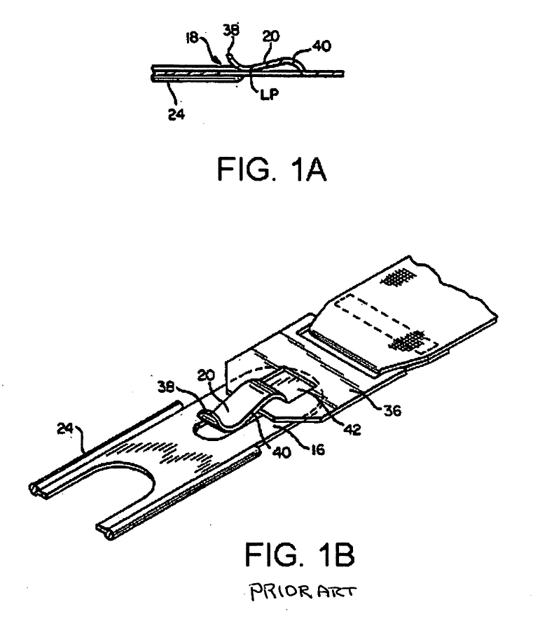

The invention is distinct from the prior art methods. For example, the tool does not utilize a “clasping” means taught by the Reese patent with a “low point” of an undulating “tongue-like” flange 20 having a radius and being under tension. The Reese mechanism is illustrated in FIGS. 1A and 1B. As stated in the Reese patent, the flange 20 “preferably is deformed in a manner such that it behaves as a tension clip”.

The tool of the present invention stands upright in relation to the tool shank. In other words, it is not bent over and does not clasp the male seat belt apparatus.

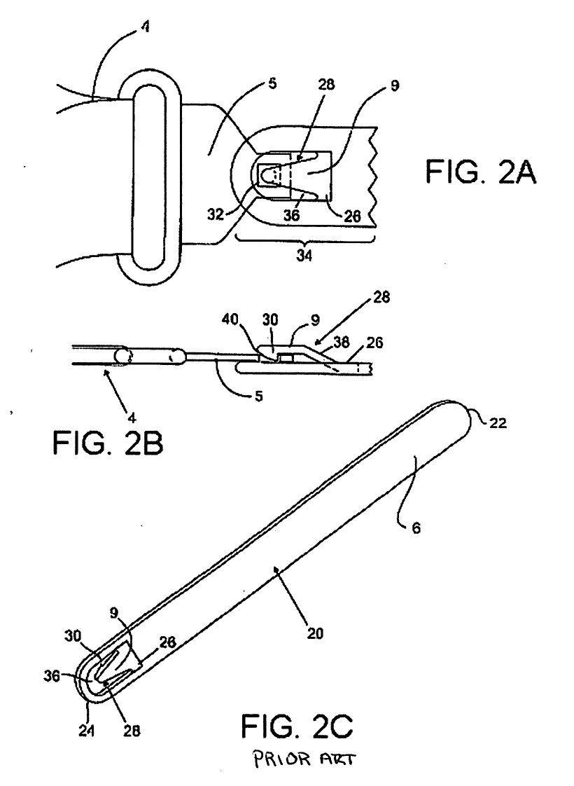

In addition, the invention does not utilize a “spring hook mechanism” 9 of the Dittmar patent wherein the free hook end 28 is oriented to the end of the shank. This mechanism of the prior art is illustrated in FIGS. 2A through 2C.

In the present invention, the lead edge of the hook member is not angled downwardly toward a hole in the shank portion and back toward the base portion of the spring tensioned hook. There is also no requirement of the applicant's invention to press open the spring hook mechanism to engage or disengage the male seat belt segment. Further the invention of the present disclosure is oriented 180° from the component of the Dittmar patent.

In addition, this specification is to be construed as illustrative only and is for the purpose of teaching those skilled in the art the manner of carrying out the invention. It is to be understood that the forms of the invention herein shown and described are to be taken as the presently preferred embodiments. As already stated, various changes may be made in the shape, size and arrangement of components or adjustments made in the steps of the method without departing from the scope of this invention. For example, equivalent elements may be substituted for those illustrated and described herein and certain features of the invention maybe utilized independently of the use of other features, all as would be apparent to one skilled in the art after having the benefit of this description of the invention.

While specific embodiments have been illustrated and described, numerous modifications are possible without departing from the spirit of the invention, and the scope of protection is only limited by the scope of the accompanying claims.

I claim:

1. A child safety restraint attachment tool comprising a handle, a shank and a hook component wherein the hook component engages with a seat belt component and the hook component is substantially 90° to a plane of the shank.

2. The tool of claim 1 further comprising a reinforcement component attached to the shank and the hook to hold the hook in a fixed position to the shank.

3. The tool of claim 1 further comprising a hook flange component attached to the hook and oriented substantially normal to the hook and parallel to the shank.

4. A method of moving a component of a seat belt device from a first position by
a) inserting a tool comprised of a shank and a hook component wherein the hook is oriented substantially 90° to the tool shank;
b) inserting the hook through an aperture of the component; and
c) pulling the tool and the component to a second position.

5. The method of claim 4 further comprising a step holding the hook 90° to the tool shank using a reinforcing component.

6. The method of claim 4 further comprising using a hook flange component attached to an end of the hook component to capture the component of the seat belt device.
